(19) United States
(12) Patent Application Publication
(10) Pub. No.: US 2024/0326446 A1
(43) Pub. Date: Oct. 3, 2024

(54) RECORDING DEVICE

(71) Applicant: SEIKO EPSON CORPORATION, Tokyo (JP)

(72) Inventors: Tomoya KURASHINA, SHIOJIRI-SHI (JP); Sho ARUGA, CHINO-SHI (JP); Nobuhiko SHINOZAKI, OKAYA-SHI (JP); Haruki MIYASAKA, MATSUMOTO-SHI (JP)

(21) Appl. No.: 18/617,732

(22) Filed: Mar. 27, 2024

(30) Foreign Application Priority Data
Mar. 30, 2023 (JP) 2023-054847

(51) Int. Cl. B41J 2/165; B41J 11/04

(52) U.S. Cl. CPC B41J 2/16547; B41J 11/04

(57) ABSTRACT

A cap portion includes a first edge portion that is a portion configured to come into contact with the head surface and that extends in the medium width direction and a second edge portion that is a portion configured to come into contact with the head surface, that is located downstream of the first edge portion in the medium conveying direction, and that extends in the medium width direction. One of the first edge portion and the second edge portion is provided with a wiper. The cap portion is movable moving along the medium conveying direction, to a first position at which the cap portion faces the head surface and a second position to which the cap portion retreats from the first position. The wiper wipes the head surface when the cap portion moves from the first position to the second position.

The present application is based on, and claims priority from JP Application Serial Number 2023-054847, filed Mar. 30, 2023, the disclosure of which is hereby incorporated by reference herein in its entirety.

### BACKGROUND

### 1. Technical Field

The present discloser relates to a recording device that performs recording on a medium.

### 2. Related Art

JP-A-2016-68503 discloses a configuration in which a wiper moves relative to a liquid discharge head to wipe the discharge surface of the liquid discharge head in a liquid discharge apparatus. The wiper is provided in a dedicated wiper holder. The wiper holder is provided with a rack. A pinion meshes with the rack. A rack and pinion mechanism moves the wiper holder to the discharge surface. The wiper holder is provided in a non-recording region in the sheet width direction. When the discharge surface is wiped by the wiper, the carriage including the liquid discharge head moves to the non-recording region.

In a case in which the liquid discharge head is a line head in which liquid discharge nozzles are provided over the entire region in the sheet width direction, if the wiper is configured to move in the sheet width direction, a long time is required for wiping. However, if the wiper is configured to move in the sheet conveying direction in order to avoid such a problem, it is difficult to secure a space for installing the wiper holder.

### SUMMARY

In order to solve the above problem, a recording device according to the present disclosure includes a liquid discharge head configured to discharge liquid to a medium, the liquid discharge head being elongated in a medium width direction, the medium width direction being a direction intersecting a medium conveying direction, and a cap portion configured to cover a head surface of the liquid discharge head, in which the cap portion includes a first edge portion extending in the medium width direction, the first edge portion being a portion configured to come into contact with the head surface, and a second edge portion located downstream of the first edge portion in the medium conveying direction and extending in the medium width direction, the second edge portion being a portion configured to come into contact with the head surface, one of the first edge portion and the second edge portion is provided with a wiper extending in the medium width direction and being elastically deformable, the cap portion is movable, by moving along the medium conveying direction by power of a first motor, to a first position at which the cap portion faces the head surface and a second position to which the cap portion retreats from the first position, and the wiper wipes the head surface when the cap portion moves from the first position to the second position in a state in which the wiper is configured to come into contact with the head surface.

A recording device according to the present disclosure includes a liquid discharge head configured to discharge liquid to a medium, the liquid discharge head being elongated in a medium width direction, the medium width direction being a direction intersecting a medium conveying direction, and a cap portion configured to cover a head surface of the liquid discharge head, in which the cap portion includes a first edge portion extending in the medium width direction, the first edge portion being a portion configured to come into contact with the head surface, and a second edge portion located upstream or downstream of the first edge portion in the medium conveying direction and extending in the medium width direction, the second edge portion being a portion configured to come into contact with the head surface, the cap portion is movable, by moving along the medium conveying direction by power of a first motor, to a first position at which the cap portion faces the head surface and a second position to which the cap portion retreats from the first position, a distance between the first edge portion and the head surface is shorter than a distance between the second edge portion and the head surface in a state in which the cap portion is at the first position and the cap portion is separated from the liquid discharge head, and the first edge portion wipes the head surface when the cap portion moves from the first position to the second position in a state in which the first edge portion is configured to come into contact with the head surface.

### BRIEF DESCRIPTION OF THE DRAWINGS

FIG. 1 is a diagram illustrating the entire medium conveyance path of a printer.

FIG. 2 is a block diagram illustrating the control system of a printer.

FIG. 3 is a diagram illustrating a positional relationship between a cap portion and a head surface when the cap portion is seen in plan view.

FIG. 4 is a diagram illustrating a part of the medium conveyance path in a state in which a facing portion is at the recording position, a cap portion is at the first position, and a line head is at the first ink discharge position.

FIG. 5 is a diagram illustrating a part of the medium conveyance path in a state in which the facing portion is at the retreat position, the cap portion is at the first position, and the line head is at the first ink discharge position.

FIG. 6 is a diagram illustrating a part of the medium conveyance path in a state in which the facing portion is at the retreat position, the cap portion is at the first position, and the line head is at the wiping position.

FIG. 7 is a diagram illustrating a part of the medium conveyance path in a state in which the facing portion is at the retreat position, the cap portion is at the second position, and the line head is at the wiping position.

FIG. 8 is a diagram illustrating a part of the medium conveyance path in a state in which the facing portion is at the retreat position, the cap portion is at the first position, and the line head is at the cap position.

FIG. 9 is a diagram illustrating another embodiment in a state where a facing portion is at the retreat position, a cap portion is at the first position, and a line head is at the first ink discharge position.

FIG. 10 is a diagram illustrating another embodiment in a state in which the facing portion is at the retreat position, the cap portion is at the first position, and the line head is at the wiping position.

FIG. 11 is a diagram illustrating another embodiment in a state where the facing portion is at the retreat position, the cap portion is at the second position, and the line head is at the wiping position.

FIG. 12 is a diagram illustrating the state transition of a cap unit according to another embodiment.

FIG. 13 is a diagram illustrating a positional relationship between the cap portion and the head surface when the cap portion is seen in plan view.

FIG. 14 is a diagram illustrating another embodiment in a state where the facing portion is at the recording position and the line head is at the first ink discharge position.

FIG. 15 is a diagram illustrating another embodiment in a state where the facing portion is located between the recording position and the retreat position and the line head is at the first ink discharge position.

FIG. 16 is a diagram illustrating another embodiment in a state where the facing portion is at the recording position and the line head is at the first ink discharge position.

FIG. 17 is a diagram illustrating a rack member and a pinion that displace the facing portion.

### DESCRIPTION OF EMBODIMENTS

Hereinafter, the present disclosure will be schematically described.

A recording device according to a first aspect includes a liquid discharge head configured to discharge liquid to a medium, the liquid discharge head being elongated in a medium width direction that is a direction intersecting a medium conveying direction, and a cap portion configured to cover a head surface of the liquid discharge head. The cap portion includes a first edge portion that is a portion configured to come into contact with the head surface and that extends in the medium width direction and a second edge portion that is a portion configured to come into contact with the head surface, that is located downstream of the first edge portion in the medium conveying direction, and that extends in the medium width direction. One of the first edge portion and the second edge portion is provided with a wiper that extends in the medium width direction and that is elastically deformable. The cap portion is movable, by moving along the medium conveying direction by power of a first motor, to a first position at which the cap portion faces the head surface and a second position to which the cap portion retreats from the first position. The wiper wipes the head surface when the cap portion moves from the first position to the second position in a state in which the wiper is configured to come into contact with the head surface.

According to the present aspect, since the wiper is provided on the cap portion in this manner, a dedicated holder for providing the wiper is unnecessary, and it is possible to suppress an increase in the size of the device while installing the wiper and to suppress an increase in cost.

A second aspect is an aspect dependent on the first aspect, in which the wiper is provided at the first edge portion, and the second position of the cap portion is located downstream of the first position in the medium conveying direction.

According to the present aspect, in the configuration in which the wiper is provided at the first edge portion, and the second position of the cap portion is located downstream of the first position in the medium conveying direction, the operation and effect of the first aspect described above can be obtained.

A recording device according to a third aspect includes a liquid discharge head configured to discharge liquid to a medium, the liquid discharge head being elongated in a medium width direction that is a direction intersecting a medium conveying direction, and a cap portion configured to cover a head surface of the liquid discharge head. The cap portion includes a first edge portion that is a portion configured to come into contact with the head surface and that extends in the medium width direction and a second edge portion that is a portion configured to come into contact with the head surface, that is located upstream or downstream of the first edge portion in the medium conveying direction, and that extends in the medium width direction. The cap portion is movable, by moving along the medium conveying direction by power of a first motor, to a first position at which the cap portion faces the head surface and a second position to which the cap portion retreats from the first position. A distance between the first edge portion and the head surface is shorter than a distance between the second edge portion and the head surface in a state in which the cap portion is at the first position and the cap portion is separated from the liquid discharge head. The first edge portion wipes the head surface when the cap portion moves from the first position to the second position in a state in which the first edge portion is configured to come into contact with the head surface.

According to the present aspect, since the head surface is wiped using the first edge portion which is a part of the cap portion, a dedicated wiper or a dedicated holder for providing the wiper is not required, an increase in the size of the device can be suppressed, and an increase in cost can be suppressed.

A fourth aspect is an aspect dependent on the third aspect, in which the second edge portion is located downstream of the first edge portion in the medium conveying direction, and the second position of the cap portion is located downstream of the first position in the medium conveying direction.

According to the present aspect, in the configuration in which the second edge portion is located downstream of the first edge portion in the medium conveying direction and the second position of the cap portion is located downstream in the medium conveying direction with respect to the first position, the operation and effect of the third aspect described above can be obtained.

A fifth aspect is an aspect dependent on the second or fourth aspect and further includes a facing portion disposed facing the liquid discharge head. The facing portion is movable, by moving along the medium conveying direction by power of a second motor, to a recording position, which is a position of the facing portion when recording is performed on a medium and at which the facing portion faces the liquid discharge head, and a retreat position, which is a position to which the facing portion retreats from the recording position and that is downstream of the recording position in the medium conveying direction. The cap portion located at the first position is located below the facing portion at the recording position. The liquid discharge head is movable, by moving in a direction of advancing and retreating with respect to the cap portion by power of a third motor, to a liquid discharge position, which is a position of the liquid discharge head when recording is performed on the medium, a cap position, which is a position of the liquid discharge head when the head surface is covered by the cap portion after the liquid discharge head advances to the cap portion, and a wiping position, which is a position of the liquid discharge head when the head surface is wiped. The head surface is wiped when the cap portion moves from the first position to the second position in a state in which the facing portion is located at the retreat position and the liquid discharge head is located at the wiping position.

Since the cap portion moves along the medium conveying direction, if the cap portion is further moved in the direction of advancing and retreating with respect to the liquid discharge head in addition to the medium conveying direction, a mechanism for moving the cap portion becomes complicated, which may cause an increase in cost and an increase in the size of the device.

However, according to the present embodiment, since the liquid discharge head advances toward the cap portion and the head surface is covered with the cap portion, the above-described problem can be suppressed.

A sixth aspect is an aspect dependent on the fifth aspect and further includes a first conveyance roller pair provided upstream of a position facing the liquid discharge head in the medium conveying direction and configured to convey the medium and a second conveyance roller pair provided downstream of the position facing the liquid discharge head in the medium conveying direction and configured to convey the medium. The facing portion at the retreat position is located below the second conveyance roller pair.

If the facing portion horizontally moves along the medium conveying direction, the second conveyance roller pair needs to be arranged further downstream in order to avoid interference between the second conveyance roller pair arranged downstream of the facing portion and the facing portion. When the second conveyance roller pair is disposed further downstream, the distance between the first conveyance roller pair and the second conveyance roller pair increases. As a result, the posture of the medium tends to be unstable at the position facing the liquid discharge head, and the recording quality may deteriorate.

However, according to the present aspect, since the facing portion at the retreat position is located below the second conveyance roller pair, the second conveyance roller pair can be disposed further upstream. This makes it possible to suppress the deterioration of the recording quality.

A seventh aspect is an aspect dependent on the sixth aspect, in which the second conveyance roller pair includes a driven roller configured to come into contact with a first surface of a medium, the first surface facing the liquid discharge head, and a driving roller configured to come into contact with a second surface opposite to the first surface.

Hereinafter, the present disclosure will be specifically described.

An inkjet printer 1 will be described below as an example of a recording device that performs recording on a medium. Hereinafter, the inkjet printer 1 is simply referred to as the printer 1.

Note that, in an X-Y-Z coordinate system illustrated in each figure, an X-axis direction is a device width direction and is a width direction of a medium on which the recording is performed. When viewed from the operator of the printer 1, the +X direction is the left side and the −X direction is the right side.

A Y-axis direction is a device depth direction, and is along a medium conveying direction at the time of the recording. A +Y direction is a direction from the device back surface toward the front surface, and −Y direction is a direction from the device front surface toward the back surface of the device. In the present embodiment, among the side surfaces constituting the periphery of the printer 1, the side surface in the +Y direction is the device front surface, and the side surface in the −Y direction is the device back surface.

A Z-axis direction is a direction along a vertical direction, and is a device height direction. A +Z direction is the vertically upward direction, and the −Z direction is the vertically downward direction.

In the description below, a direction in which the medium is sent may be referred to as “downstream” and a direction opposite thereto may be referred to as “upstream”.

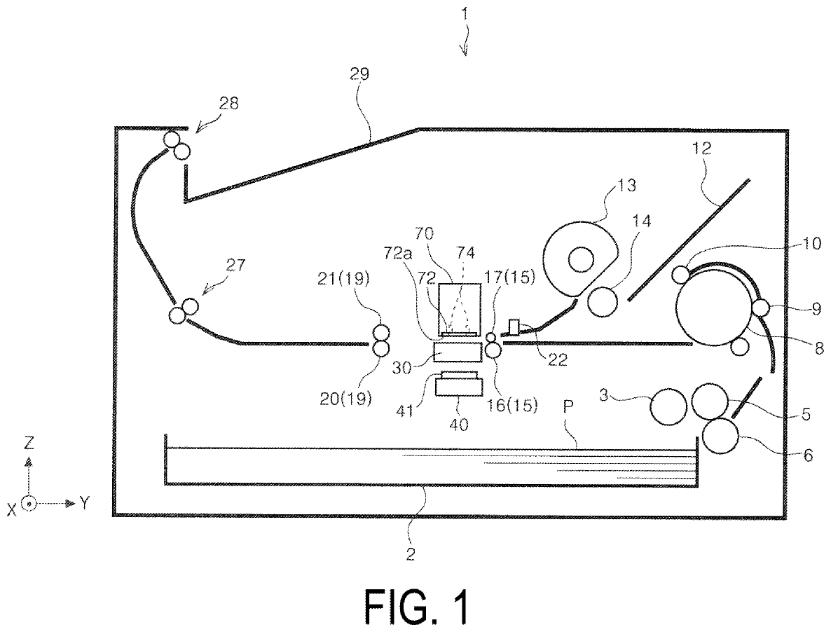

Next, the medium conveyance path of the printer 1 will be described with reference to FIG. 1. As illustrated in FIG. 1, the printer 1 includes a medium storing cassette 2, which is an example of a medium storage unit, at the bottom of the device. Reference sign P denotes a medium stored in the medium storing cassette 2. An example of a medium is a recording sheet. The medium storing cassette 2 is provided so as to be detachable from the front side of the device.

A pick roller 3 driven by a motor (not illustrated) is provided on an upper portion of the medium storing cassette 2. The pick roller 3 is movable forward and backward with respect to the media stored in the medium storing cassette 2 and rotates in contact with a medium stored in the medium storing cassette 2 to feed the medium from the medium storing cassette 2 in the +Y direction.

A feeding roller 5 driven by a motor (not illustrated) and a separation roller 6 to which a rotational torque is applied by a torque limiter (not illustrated) are provided downstream of the medium storing cassette 2. The medium fed from the medium storing cassette 2 is separated by being nipped between the feeding roller 5 and the separation roller 6 and is further fed downstream.

A reversing roller 8 driven by a motor (not illustrated) is provided downstream of the feeding roller 5 and the separation roller 6. A first nip roller 9 and a second nip roller 10 are provided around the reversing roller 8, and the medium is nipped by the reversing roller 8 and the first nip roller 9, further nipped by the reversing roller 8 and the second nip roller 10, and converted. The conveying direction of the medium is reversed from the +Y direction to the −Y direction by the reversing roller 8, and the medium is conveyed downstream.

A first conveyance roller pair 15 including a driving roller 16 driven by a motor (not illustrated) and a driven roller 17 that can be driven to rotate is provided downstream of the reversing roller 8. A medium is conveyed to a position facing a line head 70 by the first conveyance roller pair 15.

The printer 1 includes a medium feeding path from a medium support unit 12 in addition to the medium feeding path from the medium storing cassette 2. The medium support unit 12 supports a medium in an inclined posture, and the supported medium is conveyed to the first conveyance roller pair 15 by the feeding roller 13 driven by a motor (not illustrated). Reference sign 14 denotes a separation roller to which rotational torque is applied by a torque limiter (not illustrated).

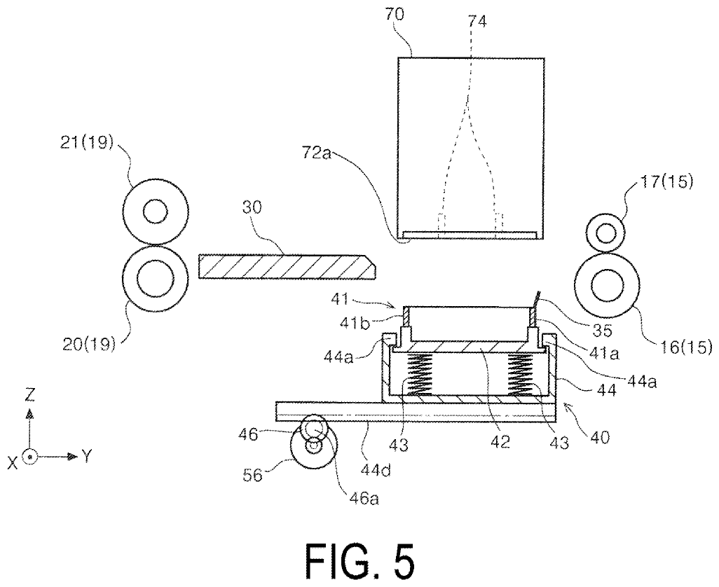

A medium detection unit 22 is provided upstream of the first conveyance roller pair 15. A control unit 50 (see FIG. 5) described later can position the leading end of a medium with respect to the line head 70 based on the detection information of the medium detection unit 22 and can position the medium at, for example, a recording start position.

The line head 70 discharges ink, which is an example of liquid discharge head, onto the image forming surface of the medium to execute recording. The line head 70 is a liquid discharge head in which a plurality of nozzles 74 that discharge ink are arranged so as to cover the entire region in the medium width direction. The line head 70 is long in the medium width direction and is configured as a liquid discharge head capable of performing recording over the entire medium width without moving in the medium width direction.

Reference sign 72a denotes a head surface that faces a medium. The head surface 72a can also be referred to as a liquid discharge surface or a nozzle surface. The head surface 72a is formed by a plate member 72. The nozzles 74 are arranged in a region of the head surface 72a.

The printer 1 includes an ink storing unit (not illustrated), and the ink discharged from the line head 70 is supplied from the ink storing unit to the line head 70 via an ink tube (not illustrated).

A facing portion 30 is provided at a position facing the head surface 72a of the line head 70. The facing portion 30 according to the present embodiment defines a gap between a medium and the head surface 72a by supporting the medium. Hereinafter, the gap between the medium and the head surface 72a may be referred to as a platen gap.

The facing portion 30 is provided so as to be movable along the medium conveying direction, which will be described later again.

A cap portion 41 that covers the head surface 72a of the line head 70 is provided below the facing portion 30. The cap portion 41 is provided on a cap unit 40.

Here, the line head 70 is provided so as to be movable in a direction in which the line head 70 advances and retreats with respect to the facing portion 30, that is, in a direction in which the platen gap is adjusted. In the present embodiment, the platen gap adjusting direction is parallel to the Z-axis direction. Hereinafter, the movement of the line head 70 in the +Z-axis direction may be referred to as “upward movement”, and the movement of the line head 70 in the −Z-axis direction may be referred to as “downward movement”.

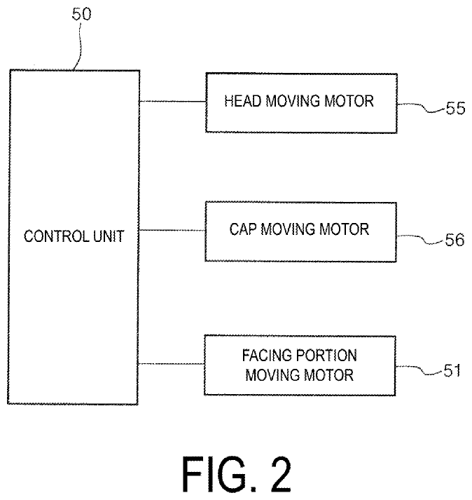

The line head 70 is displaced in the Z-axis direction by the power of a head moving motor 55 (see FIG. 2) as an example of the third motor while being guided in the Z-axis direction by a guide portion (not illustrated). The power of the head moving motor 55 is transmitted via a rack and pinion mechanism including a rack (not illustrated) provided on the line head 70 and a pinion (not illustrated) meshing with the rack. The rack and pinion mechanism is provided near both ends in the medium width direction with respect to the line head 70.

Referring to FIG. 2, reference sign 50 denotes a control unit for controlling the head moving motor 55. The control unit 50 is a control unit that controls the entire printer 1. The control unit 50 also controls a medium conveyance motor (not illustrated), the line head 70, and the like, which are not illustrated in FIG. 2.

When the line head 70 moves upward, the line head abuts on an upward movement restriction portion (not illustrated), and further upward movement is restricted. The control unit 50 detects an increase in the motor drive current value when the line head 70 abuts on the upward movement restriction portion, thereby being able to grasp that the line head 70 is located at the upward movement limit position.

Note that the head moving motor 55 is provided with an encoder sensor (not illustrated) to allow the control unit 50 to detect the rotation amount of the head moving motor 55. This enables the control unit 50 to detect the movement amount of the line head 70 from the upward movement limit position, that is, can grasp the current position of the line head 70.

Based on the medium type included in the received print data, the control unit 50 moves up and down the line head 70 according to the thickness of the medium and adjusts the platen gap. For example, assuming that the position of the line head 70 when recording is performed on plain paper is a first ink discharge position, when recording is performed on special paper thicker than plain paper, the line head 70 is positioned at a second ink discharge position higher than the first ink discharge position.

Note that the movement region of the line head 70 includes, in addition to the plurality of recording positions as described above, a cap position that is a position when the line head is capped by the cap portion 41 described later and a wiping position that is a position when the head surface 42a is wiped.

In the present embodiment, the above-described respective positions of the line head 70 include the cap position, the wiping position, the first ink discharge position, and the second ink discharge position in order toward the +Z direction.

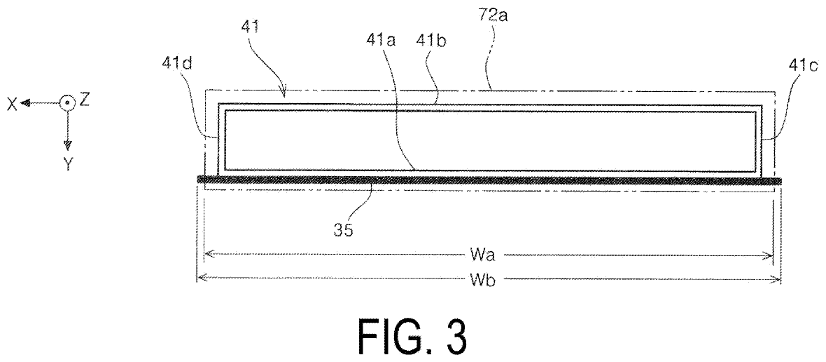

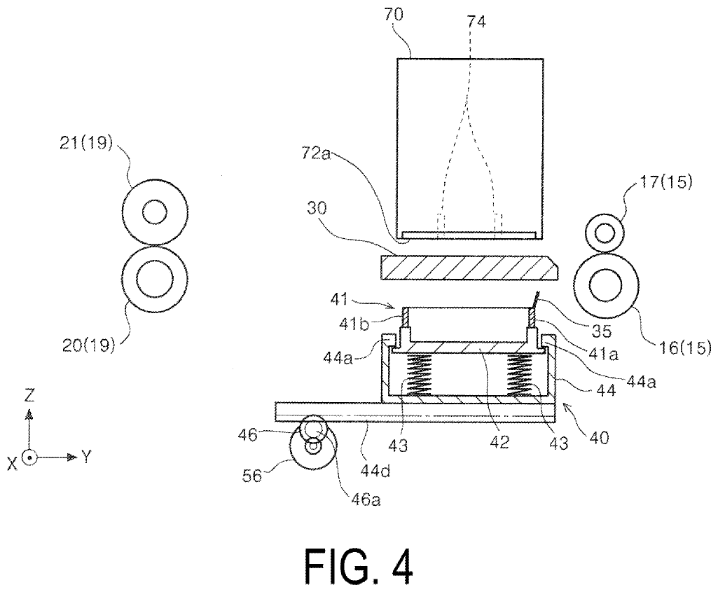

The cap portion 41 has a shape elongated in the medium width direction (see FIG. 3) and is made of an elastic material such as rubber. As illustrated in FIG. 4, the cap portion 41 is supported by a cap support portion 42 made of a resin material or the like.

The cap support portion 42 is held by a base portion 44 so as to be displaceable in the Z-axis direction, and the limit of movement in the +Z direction is defined by a restriction portion 44a formed at the base portion 44. The cap support portion 42 is pressed in the +Z direction by a cap spring 43 which is an example of a pressing member.

A waste liquid tube (not illustrated) is coupled to the cap portion 41. The waste liquid tube is coupled to a pump (not illustrated), and waste liquid is sent to a waste liquid collection unit (not illustrated) by the action of the pump. When the pump is operated with the cap portion 41 covering the head surface 72a, a negative pressure is generated in the cap portion 41, whereby ink is sucked from the nozzles 74 of the line head 70.

When the head surface 72a is covered with the cap portion 41, the cap portion 41 is slightly pushed down in the −Z direction against the pressing force of the cap spring 43, whereby the cap portion 41 comes into close contact with the head surface 72a.

When the power is turned off or in a recording standby state, the control unit 50 positions the facing portion 30 at a retreat position described below and positions the line head 70 at a capping position. Thus, the head surface 72a of the line head 70 is covered with the cap portion 41.

Referring back to FIG. 1, a second conveyance roller pair 19 including a driving roller 20 driven by a motor (not illustrated) and a driven roller 21 capable of being driven and rotated is provided downstream of the line head 70. The driven roller 21 is a driven roller that comes into contact with the first surface of a medium which faces the line head 70, and the driving roller 20 is a driving roller that comes into contact with the second surface opposite to the first surface. The medium on which recording has been performed is conveyed downstream by the second conveyance roller pair 19.

A third conveyance roller pair 27 is provided downstream of the second conveyance roller pair 19, and a discharge roller pair 28 is further provided downstream of the third conveyance roller pair 27. A portion between the third conveyance roller pair 27 and the discharge roller pair 28 is configured as a face-down discharge path, and the medium on which recording has been performed is discharged to a discharge tray 29 by the discharge roller pair 28 in a state in which the latest recording surface faces down.

Next, the cap portion 41 and the facing portion 30 will be further described with reference to FIG. 3 and subsequent drawings.

The facing portion 30 is a member elongated along the medium width direction and is supported by a guide member (not illustrated) so as to be movable along the Y-axis direction which is the medium conveying direction. A rack portion (not illustrated) is formed at the lower portion of the facing portion 30 along the medium conveying direction. A pinion gear (not illustrated) driven by a facing portion moving motor 51 (see FIG. 2) which is an example of the second motor meshes with the rack portion to form a rack-and-pinion mechanism. The rack and pinion mechanism is provided at both end portions of the facing portion 30 in the medium width direction. The facing portion 30 moves along the medium width direction by the rotation of the facing portion moving motor 51.

When the facing portion 30 moves to the end portion in the +Y direction and the end portion in the −Y direction, the facing portion 30 comes into contact with a movement restriction portion (not illustrated), and further movement is restricted. By detecting an increase in the motor drive current value when the facing portion 30 comes into contact with the movement restriction portion, the control unit 50 can recognize that the facing portion 30 is positioned at the movement limit position in the +Y direction or can recognize that the facing portion 30 is positioned at the movement limit position in the −Y direction. However, the method of detecting the position of the facing portion 30 is not limited thereto, and for example, a contact type or non-contact type sensor may be used to detect the position of the facing portion 30.

Hereinafter, the movement limit position of the facing portion 30 in the +Y direction is referred to as a recording position, and the movement limit position of the facing portion 30 in the −Y direction is referred to as a retreat position. The recording position is the position of the facing portion 30 when recording is performed on the medium by the line head 70. The retreat position is the position of the facing portion 30 when the head surface 72a of the line head 70 is covered by the cap portion 41. When the facing portion 30 is at the recording position, a medium is supported by the facing portion 30. In addition, the head surface 72a of the line head 70 can be covered with the cap portion 41 as the facing portion 30 moves from the recording position to the retreat position.

Next, as illustrated in FIG. 3, the cap portion 41 includes a first edge portion 41a extending in the medium width direction, a second edge portion 41b located downstream of the first edge portion 41a in the medium conveying direction and extending in the medium width direction, a third edge portion 41c coupling the −X direction end portions of the first edge portion 41a and the second edge portion 41b and extending in the medium conveying direction, and a fourth edge portion 41d coupling the +X direction end portions of the first edge portion 41a and the second edge portion 41b and extending in the medium conveying direction. The cap portion 41 has a rectangular shape elongated in the medium width direction in plan view, which is formed by the first edge portion 41a, the second edge portion 41b, the third edge portion 41c, and the fourth edge portion 41d. The first edge portion 41a, the second edge portion 41b, the third edge portion 41c, and the fourth edge portion 41d are portions that are pressed against the head surface 72a.

In the present embodiment, the first edge portion 41a is provided with a wiper 35 for wiping the head surface 72a. The wiper 35 is made of an elastic material such as rubber and can be elastically deformed when pressed against the head surface 72a.

As illustrated in FIG. 3, the wiper 35 is a member elongated in the medium width direction and is formed to have a length capable of wiping the entire region of the head surface 72a in the medium width direction. Referring to FIG. 3, widths Wa and Wb are the widths of the head surface 72a and the wiper 35, respectively, in the medium width direction. The width Wb is larger than the width Wa.

The cap portion 41 abuts against the head surface 72a on the inner side with respect to the edge of the head surface 72a.

In the present embodiment, the wiper 35 is formed integrally with the first edge portion 41a. In the present embodiment, the thickness of the wiper 35 is smaller than the thickness of the first edge portion 41a but may be the same as the thickness of the first edge portion 41a or may be larger than the thickness of the first edge portion 41a.

As illustrated in FIG. 4, the wiper 35 is provided so as to be slightly inclined with respect to the Z-axis direction, and more specifically, inclined so as to fall to the outside of the cap portion 41.

Next, as illustrated in FIG. 4, a rack portion 44d is formed at the base portion 44 constituting the cap unit 40. The pinion gear 46 meshes with the rack portion 44d to constitute a rack-and-pinion mechanism. The rack and pinion mechanism is provided near both ends in the medium width direction with respect to the cap unit 40.

The pinion gear 46 is provided on a shaft 46a extending in the medium width direction. One of the pinion gears 46 provided near both ends of the cap unit 40 in the medium width direction receives power from a cap moving motor 56, which is an example of the first motor, and rotates. The cap moving motor 56 is controlled by the control unit 50 (see FIG. 2).

When the cap unit 40 moves to the end portion in the +Y direction and the end portion in the −Y direction, the cap unit abuts on a movement restriction portion (not illustrated), and further movement is restricted. By detecting an increase in the motor drive current value when the cap unit 40 comes into contact with the movement restriction portion, the control unit 50 can recognize that the cap unit 40 is positioned at the movement limit position in the +Y direction or can recognize that the cap unit 40 is positioned at the movement limit position in the −Y direction. However, the method of detecting the position of the cap unit 40 is not limited thereto, and for example, a contact type or non-contact type sensor may be used to detect the position of the cap unit 40.

Hereinafter, the movement limit position of the cap unit 40 in the +Y direction is referred to as the first position of the cap portion 41, and the movement limit position of the cap unit 40 in the −Y direction is referred to as the second position of the cap portion 41. The first position is a position where the cap portion 41 faces the head surface 72a of the line head 70.

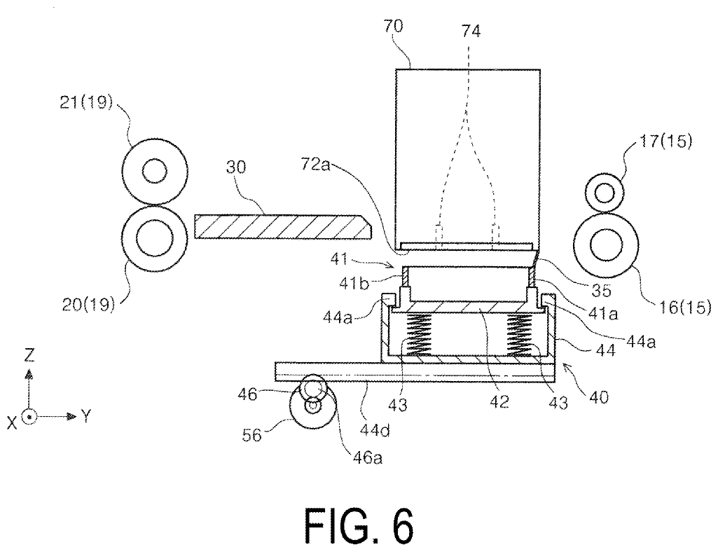

When wiping the head surface 72a by the wiper 35, starting from the state illustrated in FIG. 4, that is, the state in which the facing portion 30 is at the recording position, the cap portion 41 is at the first position, and the line head 70 is at the first ink discharge position, the control unit 50 moves the facing portion 30 from the recording position to the retreat position as indicated by the change from FIG. 4 to FIG. 5. In the state illustrated in FIG. 4, the line head 70 may be located at the second ink discharge position or another position, i.e., another position above the facing portion 30. Next, the control unit 50 moves the line head 70 from the first ink discharge position to the wiping position as indicated by the change from FIG. 5 to FIG. 6. This makes it possible to press the wiper 35 against the head surface 72a. When the line head 70 is moved to the wiping position, the wiper 35 may be positioned in the +Y direction from the head surface 72a.

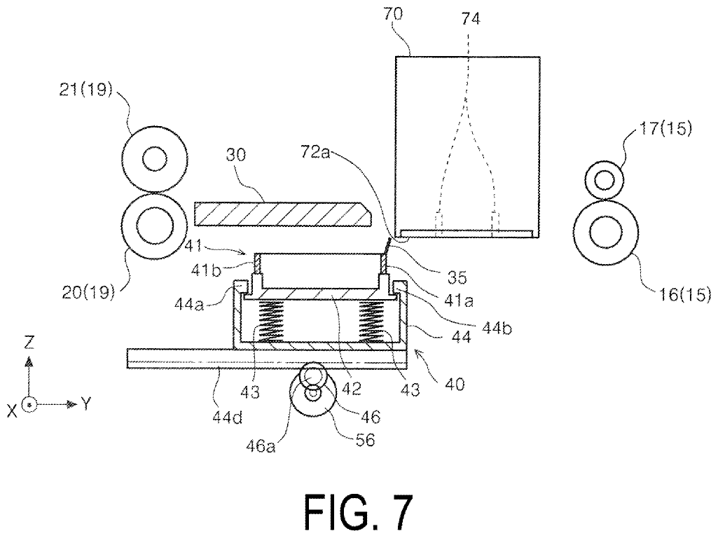

The control unit 50 then moves the cap portion 41 from the first position to the second position as indicated by the change from FIG. 6 to FIG. 7. As a result, the head surface 72a is wiped by the wiper 35.

When the wiper 35 is separated from the head surface 72a in the −Y direction, the wiper 35 deformed by being pressed against the head surface 72a returns to the original shape, and thus the ink attached to the wiper 35 may be scattered at that time. In order to suppress such a problem, the head moving motor 55 may be controlled to raise the line head 70 before the wiper 35 is separated from the head surface 72a so as to reduce the degree of pressing of the wiper 35 against the head surface 72a or to separate the wiper 35 from the head surface 72a.

Next, the control unit 50 controls the head moving motor 55 to raise the line head 70 to a position where the wiper 35 does not contact the head surface 72a and then returns the cap portion 41 from the second position to the first position.

Since the ink removed from the head surface 72a by the wiper 35 is taken into the cap portion 41, the ink removed using the existing configuration can be sent to the waste liquid collection unit (not illustrated).

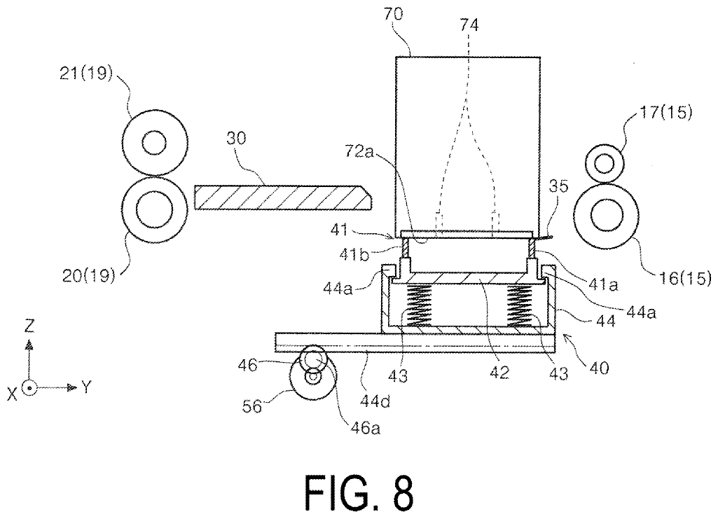

Since the wiper 35 is provided in the posture inclined outward as described above, when the head surface 72a is covered with the cap portion 41, the wiper 35 falls outward as illustrated in FIG. 8, whereby the cap portion 41 can cover the head surface 72a.

The hardness of the wiper 35, the spring load of the cap spring 43, and the like are set so that the wiper 35 can fall outward, and the cap portion 41 can come into close contact with the head surface 72a, as illustrated in FIG. 8.

As described above, the cap portion 41 includes the first edge portion 41a that is a portion that comes into contact with the head surface 72a and that extends in the medium width direction and the second edge portion 41b that is a portion that comes into contact with the head surface 72a, that is located downstream of the first edge portion 41a in the medium conveying direction, and that extends in the medium width direction. The first edge portion 41a is provided with the wiper 35 that extends in the medium width direction and that is elastically deformable.

The cap portion 41 is movable to a first position facing the head surface 72a and a second position retreated from the first position by moving along the medium conveying direction by the power of the cap moving motor 56.

When the cap portion 41 moves from the first position to the second position in a state in which the wiper 35 can contact the head surface 72a, the wiper wipes the head surface 72a.

This eliminates the necessity of a dedicated holder for providing the wiper 35 and makes it possible to suppress an increase in the size of the device while installing the wiper 35 and to suppress an increase in cost.

Further, since the wiper 35 wipes the head surface 72a of the line head 70 elongated in the medium width direction along the medium conveying direction, the wiping time can be shortened.

In the present embodiment, the wiper 35 is provided at the first edge portion 41a, and the second position of the cap portion 41 is located downstream of the first position in the medium conveying direction.

However, instead of such a configuration, the wiper 35 may be provided at the second edge portion 41b, and the second position of the cap portion 41 may be located upstream of the first position in the medium conveying direction.

In the present embodiment, the facing portion 30 is disposed facing the line head 70. The facing portion 30 is movable, by moving along the medium conveying direction by the power of the facing portion moving motor 51, to the recording position, which is the position of the facing portion 30 when recording is performed on the medium and at which the facing portion 30 faces the line head 70, and to the retreat position to which the facing portion 30 retreats from the recording position and that is downstream of the recording position in the medium conveying direction.

The cap portion 41 located at the first position is located below the facing portion 30 at the recording position. The line head 70 is movable, by moving in the direction of advancing and retreating with respect to the cap portion 41 by the power of the head moving motor 55, to the ink discharge position, which is a position when recording is performed on a medium, the cap position, which is a position when the head surface 72a is covered with the cap portion 41 after the line head 70 advances to the cap portion 41, and the wiping position, which is a position when the head surface 72a is wiped. The cap portion 41 then moves from the first position to the second position in a state in which the facing portion 30 is located at the retreat position and the line head 70 is located at the wiping position, thereby wiping the head surface 72a.

Since the cap portion 41 moves along the medium conveying direction, if the cap portion is further moved in the direction of advancing and retreating with respect to the line head 70 in addition to the medium conveying direction, a mechanism for moving the cap portion 41 becomes complicated, which may cause an increase in cost and an increase in the size of the device. However, according to the present embodiment, since the line head 70 advances toward the cap portion 41 and the head surface 72a is covered with the cap portion 41, the above-described problem can be suppressed.

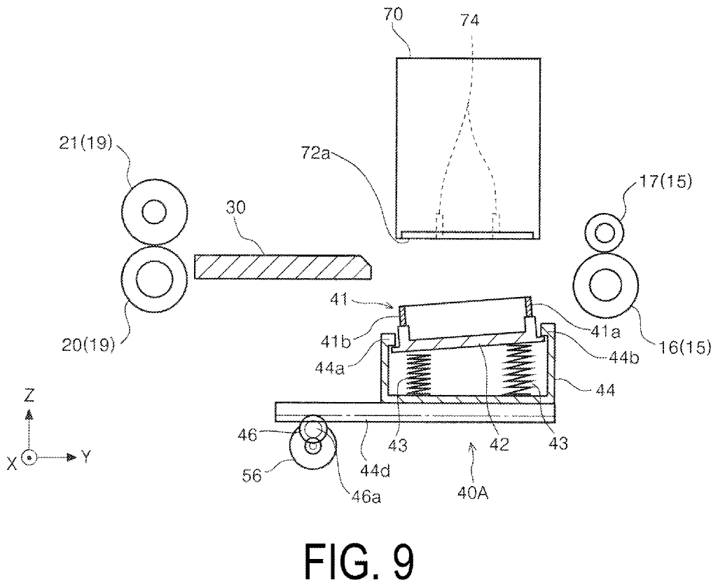

Another embodiment will be described next with reference to FIGS. 9 to 13.

The present embodiment is different from the above-described embodiment in that a first edge portion 41a of a cap portion 41 serves as a wiper.

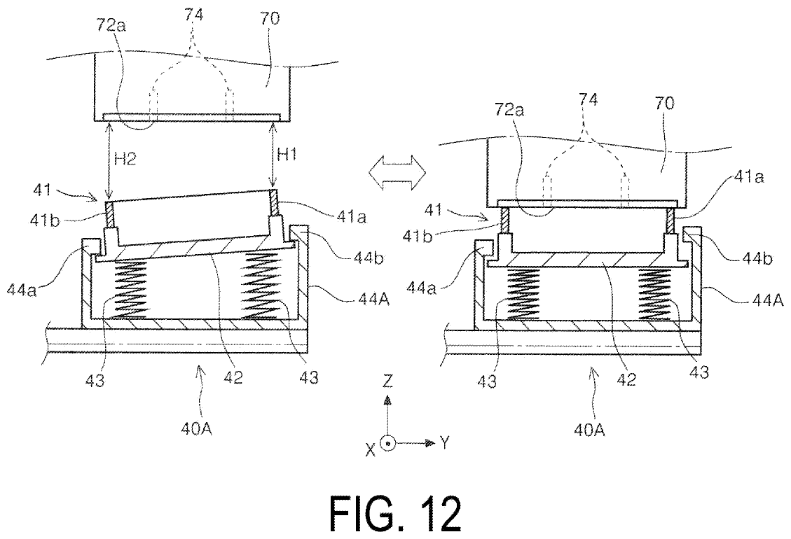

As illustrated in FIG. 12, in a cap unit 40A according to the present embodiment, a restriction portion that defines the movement limit of a cap support portion 42 in the +Z direction in a base portion 44A includes a restriction portion 44a located downstream in the medium conveying direction and a restriction portion 44b that is a restriction portion located upstream in the medium conveying direction and that is located farther in the +Z direction than the restriction portion 44a. As a result, in a cap portion 41, a second edge portion 41b downstream is positioned farther in the −Z direction than a first edge portion 41a upstream.

The left diagram in FIG. 12 illustrates a state in which the cap portion 41 is separated from a head surface 72a, and in this state, a distance H1 between the first edge portion 41a and the head surface 72a is shorter than a distance H2 between the second edge portion 41b and the head surface 72a. As a result, the cap portion 41 is in an inclined state. However, as illustrated in the right diagram in FIG. 12, in a state in which the cap portion 41 covers the head surface 72a, the cap portion 41 is pushed down by the head surface 72a, and the inclined state of the cap portion 41 is canceled and becomes parallel to the head surface 72a.

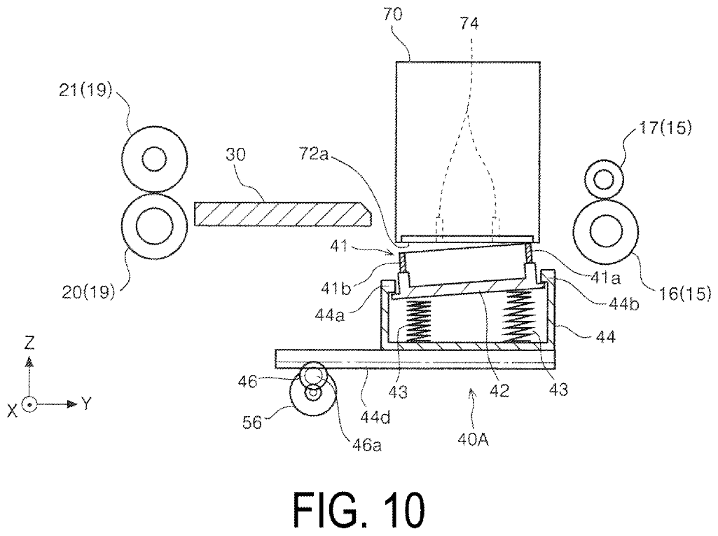

In the configuration including the cap unit 40A described above, when wiping the head surface 72a, the control unit 50 moves the line head 70 to the wiping position as indicated by the change from FIG. 9 to FIG. 10. As a result, the first edge portion 41a of the cap portion 41 is pressed against the head surface 72a. At this time, the cap portion 41 is located at the first position, but the cap portion 41 may be slightly moved to be farther in the +Y direction than the first position so that the first edge portion 41a of the cap portion 41 is located upstream of the head surface 72a.

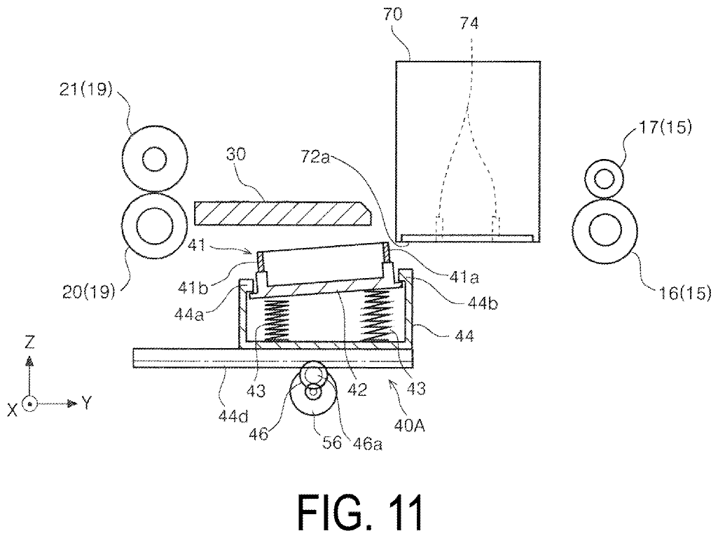

From this state, the control unit 50 moves the cap portion 41 to the second position as indicated by the change from FIG. 10 to FIG. 11. As a result, the first edge portion 41a of the cap portion 41 wipes the head surface 72a. Since the ink removed from the head surface 72a by the first edge portion 41a is taken into the cap portion 41, the ink removed using the existing configuration can be sent to the waste liquid collection unit (not illustrated).

In the configuration in which the distance H1 between the first edge portion 41a and the head surface 72a is shorter than the distance H2 between the second edge portion 41b and the head surface 72a in a state in which the cap portion 41 is at the first position, and the cap portion 41 is separated from the line head 70 in this manner, as described with reference to FIG. 12, the first edge portion 41a can wipe the head surface 72a by moving the cap portion 41 from the first position to the second position in a state in which the first edge portion 41a can contact the head surface 72a. This eliminates the necessity of a dedicated wiper or a dedicated holder for providing the wiper and makes it possible to suppress an increase in the size of the device and to suppress an increase in cost.

In the present embodiment, the second edge portion 41b is located downstream of the first edge portion 41a in the medium conveying direction, and the second position of the cap portion 41 is located downstream of the first position in the medium conveying direction. However, instead of such a configuration, the second edge portion 41b may be located upstream of the first edge portion 41a in the medium conveying direction, and the second position of the cap portion 41 may be located upstream of the first position in the medium conveying direction. In this case, the head surface 72a is wiped when the cap portion 41 moves upstream in the medium conveying direction.

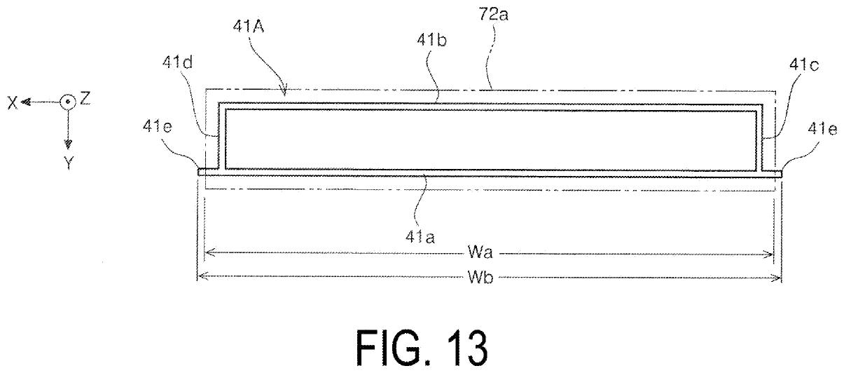

As described with reference to FIG. 3, since the cap portion 41 abuts on the head surface 72a on the inner side of the edge of the head surface 72a, both end portions of the head surface 72a in the width direction cannot be wiped when the head surface 72a is wiped using the first edge portion 41a. Therefore, like a cap portion 41A illustrated in FIG. 13, an extension portion 41e may also be provided extending the first edge portion 41a outward. Accordingly, it is possible to wipe the entire region of the head surface 72a in the width direction. The height of the extension portion 41e in the Z-axis direction is the same as that of the first edge portion 41a, and it is possible to help prevent the extension portion 41e from becoming an obstacle when the cap portion 41A covers the head surface 72a.

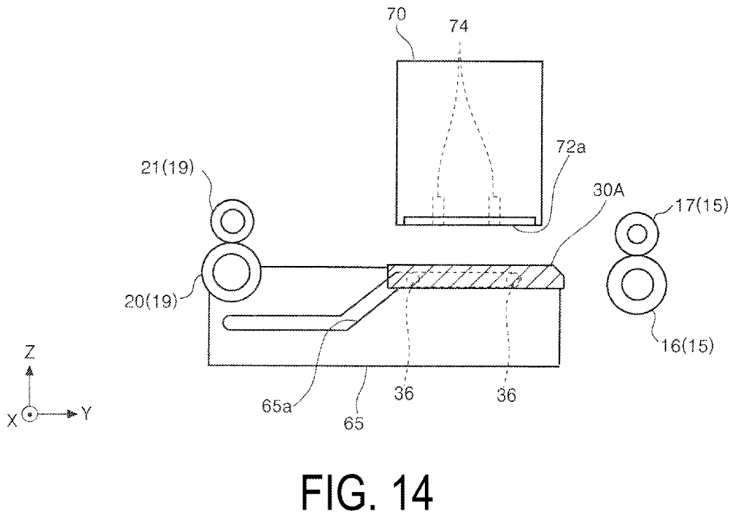

Next, another embodiment of the facing portion 30 will be described with reference to FIGS. 14 to 17. Referring to FIGS. 14 to 17, a cap unit 40 is not illustrated.

Referring to FIG. 14, reference sign 65 denotes a guide member for guiding a facing portion 30A to the recording position and the retreat position. Although not illustrated, the guide members 65 are arranged on both sides of the facing portion 30A so as to sandwich the facing portion 30A in the medium width direction.

A guide hole 65a is formed in the guide member 65. The guide hole 65a extends in parallel along the medium conveying direction from the upstream end toward the downstream in the medium conveying direction, then inclines downward toward the downstream, and again extends in parallel along the medium conveying direction.

The facing portion 30A is provided with bosses 36 in both side portions in the medium width direction. In the present embodiment, two bosses 36 are provided at intervals along the medium conveying direction. The two bosses 36 enter the guide hole 65a and are guided by the guide hole 65a.

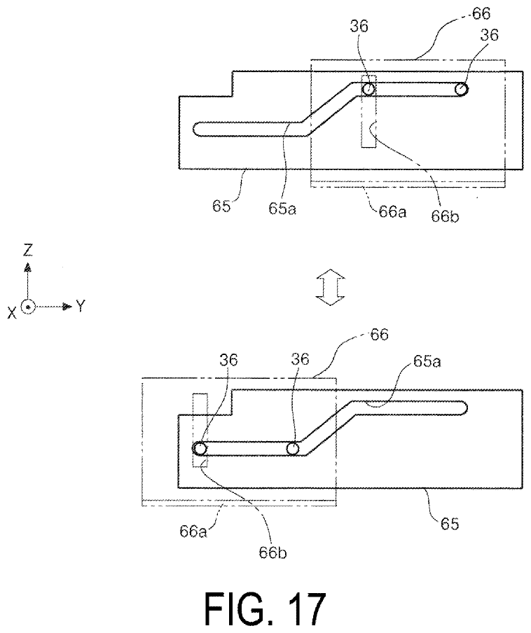

On the further outer side in the medium width direction with respect to the guide member 65, rack members 66 illustrated in FIG. 17 are provided on both sides with respect to the facing portion 30A so as to sandwich the facing portion 30A and the guide member 65. The rack member 66 is supported by a guide member (not illustrated) so as to be displaceable along the medium conveying direction. A pinion gear (not illustrated) that displaces the facing portion 30A meshes with a rack portion 66a formed at the rack member 66. When the pinion gear is rotated by the power of a facing portion moving motor 51 (refer to FIG. 2), the rack member 66 is displaced along the medium conveying direction.

An elongated hole 66b extending in the vertical direction is formed in the rack member 66. One of the bosses 36 provided in the facing portion 30A is longer in the medium width direction than the other bosses 36 and enters the elongated hole 66b. Therefore, when the rack member 66 is displaced in the medium conveying direction, the boss 36 that has entered the elongated hole 66b, that is, the facing portion 30A is displaced in the medium conveying direction. Here, when the boss 36 passes through the inclined portion of the guide hole 65a, the boss 36 is displaced in the vertical direction, but the elongated hole 66b of the rack member 66 extends in the vertical direction, whereby the boss 36 can be displaced in the elongated hole 66b in the vertical direction. With such a configuration, the boss 36, that is, the facing portion 30A can be displaced along the guide hole 65a by the rack member 66 as indicated by the change from the upper diagram to the lower diagram in FIG. 17 or as indicated by the change from the lower diagram to the upper diagram in FIG. 17.

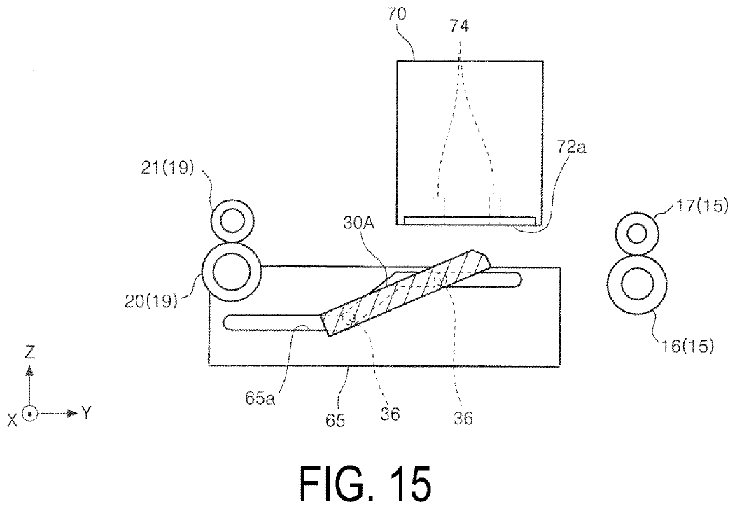

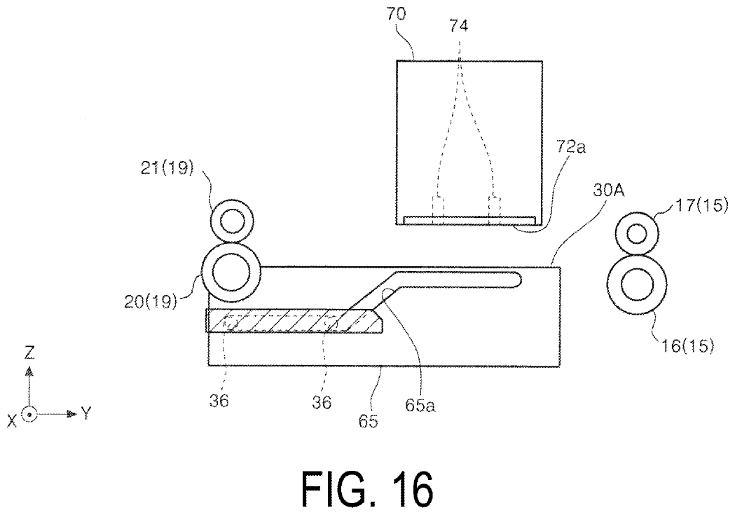

The facing portion 30 A moves from the recording position in FIG. 14 to the retreat position in FIG. 16 through the state in FIG. 15. When the facing portion 30A is at the retreat position, the facing portion is located below the second conveyance roller pair 19 as illustrated in FIG. 16. With such a configuration, the following operational effects are obtained.

If the facing portion 30A horizontally moves along the medium conveying direction, the second conveyance roller pair 19 needs to be arranged further downstream in order to avoid interference between the second conveyance roller pair 19 arranged downstream of the facing portion 30A and the facing portion 30A. When the second conveyance roller pair 19 is disposed further downstream, the distance between the first conveyance roller pair 15 and the second conveyance roller pair 19 increases. As a result, the posture of the medium tends to be unstable at the facing position facing the line head 70, and the recording quality may deteriorate.

However, as described above, since the facing portion 30A at the retreat position is located below the second conveyance roller pair 19, the second conveyance roller pair 19 can be disposed further upstream. This makes it possible to suppress the deterioration of the recording quality.

It is needless to say that the present disclosure is not limited to each embodiment described above or modification examples, and various modifications are possible within the scope of the present disclosure as described in the appended claims, which also fall within the scope of the present disclosure.

What is claimed is:

1. A recording device comprising:
a liquid discharge head configured to discharge liquid to a medium, the liquid discharge head being elongated in a medium width direction, the medium width direction being a direction intersecting a medium conveying direction; and
a cap portion configured to cover a head surface of the liquid discharge head, wherein
the cap portion includes
a first edge portion extending in the medium width direction, the first edge portion being a portion configured to come into contact with the head surface, and
a second edge portion located downstream of the first edge portion in the medium conveying direction and extending in the medium width direction, the second edge portion being a portion configured to come into contact with the head surface,
one of the first edge portion and the second edge portion is provided with a wiper extending in the medium width direction and being elastically deformable,
the cap portion is movable, by moving along the medium conveying direction by power of a first motor, to a first position at which the cap portion faces the head surface and a second position to which the cap portion retreats from the first position, and
the wiper wipes the head surface when the cap portion moves from the first position to the second position in a state in which the wiper is configured to come into contact with the head surface.

2. The recording device according to claim 1, wherein
the wiper is provided at the first edge portion and
the second position of the cap portion is located downstream of the first position in the medium conveying direction.

3. A recording device comprising:
a liquid discharge head configured to discharge liquid to a medium, the liquid discharge head being elongated in a medium width direction, the medium width direction being a direction intersecting a medium conveying direction; and
a cap portion configured to cover a head surface of the liquid discharge head, wherein
the cap portion includes
a first edge portion extending in the medium width direction, the first edge portion being a portion configured to come into contact with the head surface, and
a second edge portion located upstream or downstream of the first edge portion in the medium conveying direction and extending in the medium width direction, the second edge portion being a portion configured to come into contact with the head surface,
the cap portion is movable, by moving along the medium conveying direction by power of a first motor, to a first position at which the cap portion faces the head surface and a second position to which the cap portion retreats from the first position,
a distance between the first edge portion and the head surface is shorter than a distance between the second edge portion and the head surface in a state in which the cap portion is at the first position and the cap portion is separated from the liquid discharge head, and
the first edge portion wipes the head surface when the cap portion moves from the first position to the second position in a state in which the first edge portion is configured to come into contact with the head surface.

4. The recording device according to claim 3, wherein
the second edge portion is located downstream of the first edge portion in the medium conveying direction and
the second position of the cap portion is located downstream of the first position in the medium conveying direction.

5. The recording device according to claim 2, further comprising
a facing portion disposed facing the liquid discharge head, wherein
the facing portion is movable, by moving along the medium conveying direction by power of a second motor, to a recording position being a position of the facing portion when recording is performed on a medium and at which the facing portion faces the liquid discharge head, and a retreat position being a position to which the facing portion retreats from the recording position and that is downstream of the recording position in the medium conveying direction,
the cap portion located at the first position is located below the facing portion at the recording position,
the liquid discharge head is movable, by moving in a direction of advancing and retreating with respect to the cap portion by power of a third motor, to a liquid discharge position being a position of the liquid discharge head when recording is performed on the medium, a cap position being a position of the liquid discharge head when the head surface is covered by the cap portion after the liquid discharge head advances to the cap portion, and a wiping position being a position of the liquid discharge head when the head surface is wiped, and
the head surface is wiped when the cap portion moves from the first position to the second position in a state in which the facing portion is located at the retreat position and the liquid discharge head is located at the wiping position.

6. The recording device according to claim 5, further comprising:
a first conveyance roller pair provided upstream of a position facing the liquid discharge head in the medium conveying direction and configured to convey the medium; and
a second conveyance roller pair provided downstream of the position facing the liquid discharge head in the medium conveying direction and configured to convey the medium, wherein
the facing portion at the retreat position is located below the second conveyance roller pair.

7. The recording device according to claim 6, wherein
the second conveyance roller pair includes a driven roller configured to come into contact with a first surface of a medium, the first surface facing the liquid discharge head, and a driving roller configured to come into contact with a second surface opposite to the first surface.
